(19) United States
(12) Patent Application Publication
(10) Pub. No.: US 2008/0292079 A1
(43) Pub. Date: Nov. 27, 2008

(54) System and a method for processing presence status information with improved reliability

(75) Inventors: Francois Toutain, Louannec (FR); Philippe Bouille, Pleumeur Bodou (FR); Guillaume Collin, Goudelin (FR)

Correspondence Address: COHEN PONTANI LIEBERMAN & PAVANE LLP, Suite 1210, 551Fifth Avenue, New York, NY, 10176, US

(73) Assignee: France Telecom, Paris (FR)

(21) Appl. No.: 12/154,402

(22) Filed: May 22, 2008

(30) Foreign Application Priority Data
May 24, 2007 (FR) 0755246

(51) Int. Cl. H04M 3/42

(52) U.S. Cl. 379/201.01

(57) ABSTRACT

A method of processing the presence status of a user at at least one terminal connected to a telecommunications network on the basis of presence status information provided by at least one status source of said terminal. The presence status is weighted as a function of a pertinence value that is calculated as a function of time. The invention makes it possible over time to correct the pertinence of presence information to as maximize the reliability of a presence status calculated on the basis of said information.

### FIELD OF THE INVENTION

The present invention lies in the field of digital communications between people and it relates more particularly to managing so-called “presence” information that makes it possible to characterize the presence status of a user at one or more terminals connected to at least one telecommunications network.

### BACKGROUND OF THE INVENTION

Below, the term “presence information” is used to designate information relating to the “physical” presence of a user at a terminal.

More precisely, the presence information about a user characterizes the fact that the user is genuinely close to one of the terminals and can therefore be reached. By way of example, such information can indicate that the user is ready to receive a communication on a given terminal, or on the contrary that the user is not available since already engaged on a communication.

The presence information characterizing the presence status of a user is for transmission over the network so as to be consultable by other users, and/or by automatic applications implemented on the network, so that said users and/or applications can be informed about the current presence status of the user.

Amongst the presence management systems that are already known, there exist methods of updating the presence status of a user at a terminal on the basis of presence status information provided by at least one status source associated with the terminal.

When the user possesses a plurality of terminals connected to an Internet protocol (IP) network, it is known to use the extensible messaging and presence protocol (XMPP) to obtain presence status information as provided by at least one status source of each of the terminals, so as to identify the terminal at which the user can be reached.

Nevertheless, none of the known mechanisms makes it possible to determine with reliability the current presence status of a user. This lack of reliability is particularly troublesome when:

the frequency with which the presence information provided by the various status sources is updated is low; and/or

some status sources are not capable of updating their presence status information at a given instant, because of some failure of the source.

Each presence information unit obtained by any status source at some initial instant loses value or pertinence as said information unit becomes older. For example, if a video center of a work station interrogated at an initial instant t detects the presence of a human form, the probability that the user is at the work station at instant t is clearly high. However, at a later instant t′>t, it is possible that the user will leave the work station, in which case the presence information provided at instant t is no longer valid from instant t′.

In particular, if the change of status occurs during a time interval between two successive updating events, the presence status of the user during said time interval will be wrong, the presence information being untrue since it does not take account of the change of status.

In any event, in the present state of the art, until the information has been updated, the presence status as determined by a presence management system on the basis of said erroneous presence information is not reliable.

Amongst the solutions proposed in the prior art, it is possible to improve the pertinence of said status only if each status source provides an update of its presence status information. However, that approach requires frequent updating to be performed in order to remain reliable, and that is constricting and consumes resources.

### OBJECTS AND SUMMARY OF THE INVENTION

In accordance with one aspect, the present invention provides a solution that does not present the above drawbacks, in which the pertinence of the presence information provided by each status source is modified continuously over time in such a manner as to take account of the aging of said information. By weighting the raw presence information provided by a status source (i.e. while modifying the weight that is allocated thereto), using a weighting method for the purpose of taking account of the age of the information, the present invention makes it possible to keep the presence information relevant in optimized manner over time, without requiring an excessively high updating frequency.

More precisely, one aspect of the present invention provides a method of processing presence status information relating to the presence status of a user at a terminal, the presence status information being provided by at least one status source associated with the terminal. The method comprises a weighting step during which the information is weighted as a function of a pertinence value that is calculated as a function of time, so as to correct the weight of presence information over a determined time interval.

Weighting presence status information in accordance with one aspect of the present invention serves to correct the pertinence of the information over time so as to provide information that is more reliable. The corrected information makes it possible to maximize the reliability of the presence status of a user as determined by a presence management system, in particular when it is not possible to update the presence status information from each status source or when said updating cannot be performed sufficiently regularly.

According to another characteristic of the invention, each status source is associated with a pertinence level that is adapted to that source.

This makes it possible to take account of the way in which the pertinence of presence information varies over time in a manner that is specific to each status source, thus making it possible to obtain presence information with an improved confidence level.

According to another characteristic of the invention, a presence information unit provided by a status source is constituted by a unit presence probability, the unit presence probability being corrected during the weighting step by applying an obsolescence function to the presence probability in such a manner as to obtain a corrected presence probability, the obsolescence function defining a pertinence level that is calculated as a function of time.

Applying the obsolescence function to the presence probability makes it possible to correct (and in particular to decrease) the value of said probability over time so as to take into consideration any changes of status that might have occurred, such as the user suddenly going away from the video sensor (status source) in the above-described example.

One aspect of the present invention also provides a method of updating the presence status of a user at at least one terminal connected to a telecommunications network, on the basis of presence status information provided by at least one status source of the terminal. The presence status is determined during an aggregation step, comprising:

collecting a plurality of unit presence probability values provided by a plurality of status sources associated with said terminal;

weighting said unit presence probability values in application of the processing method as described above; and

calculating an aggregated presence status probability resulting from a linear combination of said unit presence probability values.

According to a characteristic of the invention during the aggregation step, the unit presence probability values are classified in increasing order so as to form an ordered set of values, prior to being used for calculating the aggregated presence status probability.

According to another characteristic of the invention, said aggregated presence probability P associated with said terminal is defined by P=Mₙ calculated by recurrence using the following formula:

Mᵢ=Mᵢ₋₁+Oᵢ(Vᵢ−Mᵢ₋₁)

with the following initial condition M₀=0.5; where i is a natural integer such that 1≦i≦n, with n designating the last element of said ordered set, and where Oᵢ designates the obsolescence function associated with the status source that provided the i^{th} unit presence probability value Vᵢ.

One aspect of the present invention also provides a device for processing presence status information relating to the presence status of a user at a terminal, the presence status information being provided by at least one presence source associated with the terminal. The device of the invention comprises means for weighting said presence status information as a function of a pertinence level calculated as a function of time, so as to correct the weight of presence status information over a determined time interval.

The advantages and particular embodiments of this processor device are the same as those associated with the processing method of the invention, as described above.

One aspect of the present invention also provides a system for updating the presence status of a user at at least one terminal connected to a telecommunications network, each terminal being associated with at least one status source for providing presence status information about said user. The system of the invention comprises a data aggregator device, comprising:

collector means for collecting a plurality of unit presence probability values provided by a plurality of status sources associated with said terminal;

weighting means for weighting said unit presence probability values as a function of a pertinence level calculated as a function of time; and

calculator means for calculating an aggregated presence status probability resulting from a linear combination of said unit presence probability values, so as to correct the weight of the presence status probabilities over a determined time interval.

According the invention, the system includes classifier means for classifying the unit presence probability values in increasing order so as to form an ordered set of values, prior to the values being used by the calculator means for calculating the aggregated presence status probability.

According to another characteristic of the invention, the calculator means are adapted to calculate the aggregated presence probability P defined by P=Mₙ, by recurrence using the following formula:

Mᵢ=Mᵢ₋₁+Oᵢ(Vᵢ−Mᵢ₋₁)

with the following initial condition M₀=0.5; where i is a natural integer such that 1≦i≦n, with n designating the last element of the ordered set, and where Oᵢ designates the obsolescence function associated with the status source that provided the i^{th} unit presence probability value Vᵢ.

In a variant, the various steps of the updating method or of the processing method of the invention are determined by computer program instructions.

Consequently, the invention also provides a computer program on an information recording medium, the program being suitable for being implemented in a processor device or an updating system, or more generally in a computer, said program including instructions adapted to implementing the steps of a processing method or an updating method as described above.

The computer program may use any programming language, and it may be in the form of: source code; object code; or code that is intermediate between source code and object code, such as in a partially-compiled form; or in any other desirable form.

The invention also provides an information recording medium readable by a computer and including instructions of a computer program as mentioned above.

The recording medium may be a read-only memory (ROM) or any entity or device capable of storing the computer program, such as a CD-ROM, or a microelectronic circuit ROM, or indeed a magnetic recording medium, e.g. a floppy disk, a hard disk, a programmable read-only memory (PROM), an erasable PROM (EPROM), or an electrically erasable PROM (EEPROM).

The recording medium may be a transmission medium, such as an electrical or optical signal, that can be conveyed by an electrical or optical cable, by radio, or by other means. The program of the invention may in particular be downloaded from an Internet type network. Alternatively, the recording medium may be an integrated circuit in which the program is incorporated, the circuit being adapted to execute the method in question or to be used in its execution.

### BRIEF DESCRIPTION OF THE DRAWINGS

Other characteristics and advantages of the present invention appear in the description given below with reference to the accompanying drawings that show embodiments having no limiting character. In the figures:

FIG. 1 is a diagrammatic view of a system for managing the presence of a user, which system includes an aggregator device of the present invention;

FIG. 2 is a diagrammatic view of an aggregator device of the present invention in communication with a terminal of the user;

FIGS. 3A, 3B, and 3C are diagrams showing examples of obsolescence functions used for weighting presence status information units by the weighting method in accordance with one embodiment of the present invention;

FIGS. 4A and 4B are diagrams showing examples of updating scenarios showing how the pertinence of information provided by two distinct status sources varies over time when they are weighted in accordance with one embodiment of the present invention;

FIG. 5 is a flow chart showing the steps of the aggregation method including a weighting operation implemented in an aggregator;

FIG. 6 is a diagram showing a device for processing presence status information in a particular implementation of the invention;

FIG. 7 is a flow chart showing the steps of the weighting method implemented by the device of FIG. 6; and

FIG. 8 shows an example of utilization of the presence management system of the present invention.

### DETAILED DESCRIPTION OF THE DRAWINGS

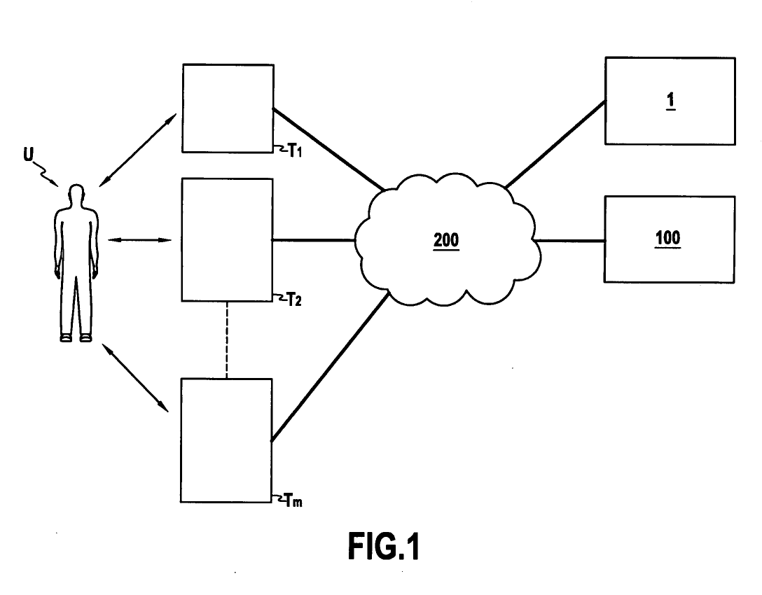

An embodiment of the present invention is described below in the context of a presence management system for updating a presence status concerning a user U possessing a plurality of terminals T₁, . . . , Tₙ connected to a telecommunications network 200, as shown diagrammatically in FIG. 1.

The terminals T₁, . . . , Tₙ may be selected from any of the following devices: a computer; a personal digital assistant (PDA); a fixed telephone terminal; a mobile telephone terminal (GSM, UMTS); or any other type of terminal suitable for communicating via the network 200.

The presence management system of FIG. 1 comprises an aggregator device 100 referred to below was an “aggregator” 100 that is constituted by a presence server connected to the terminals T₁, . . . , Tₙ via the network 200. For each terminal, the aggregator 100 is adapted to generating presence status information concerning the user, which information is for transmitting to an application server 1 via the network 200.

The network 200 covers in general manner a communications network enabling digital data to be transmitted between the aggregator 100 and user terminals. By way of example, the network 200 may be selected from any one of the following networks: an integrated digital services network (IDSN); an IP packet switched network; or a cellular network for wireless telephony (GSM, UMTS).

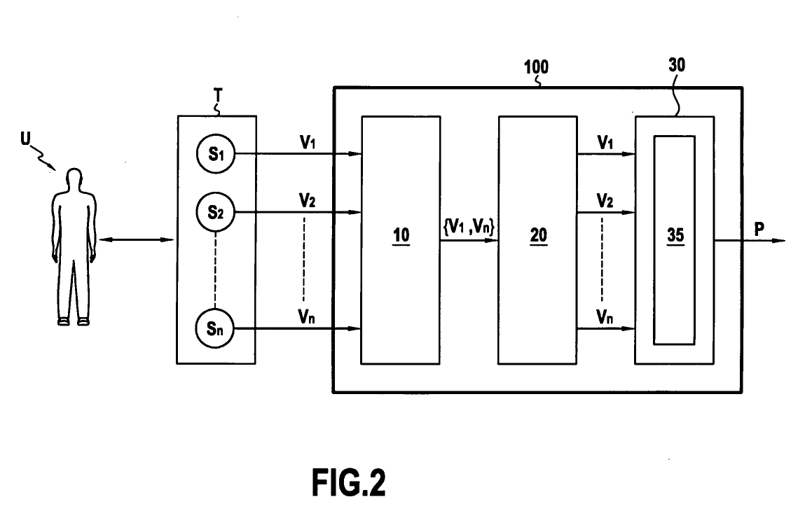

Let T be any terminal selected from the plurality of terminals T₁, . . . , Tₙ of the user U. As shown in FIG. 2, the aggregator 100 generates an aggregated presence probability concerning the user P on the basis of unit presence probabilities {Vᵢ}_{1≦i≦n} written V₁, . . . , Vₙ and provided by a plurality of status sources {Sᵢ}_{1≦i≦n} respectively written S₁, . . . , Sₙ and associated with the terminal T.

By definition, a status source Sᵢ designates in general manner hardware means and/or software means such as a computer process for implementing at least one of the following operations:

generating presence status information units Vᵢ relating to the presence of the user U at the terminal T with which the status source Sᵢ is associated; and

communicating these presence status information units Vᵢ.

The presence status information units Vᵢ are transmitted to the aggregator 100 of the invention via the network 200 (not shown in FIG. 2, but described above with reference to FIG. 1).

The presence status information provided by a status source Sᵢ is associated with a time stamp Zᵢ so that the statuses can be ordered in time for subsequent analysis.

In accordance with an embodiment of the present invention, the presence status information units as constituted by the unitary presence probabilities V₁, . . . , Vₙ provided by the respective above-described status sources S₁, . . . , Sₙ, are weighted by obsolescence functions.

By definition, the term “obsolescence function” is used below to designate a function that enables a specific weight pᵢ to be applied over time to the presence information units Vᵢ provided by each of the status sources Sᵢ. Each weight is determined depending on a pertinence level as calculated as a function of time by means of the obsolescence function, so as to correct the pertinence of the presence information coming from each status source as said information ages.

Each status source Sᵢ is associated with an obsolescence function Oᵢ that is defined over a determined time interval. An appropriate obsolescence function Oᵢ is selected in manner that matches each status source Sᵢ, thereby enabling the highly variable behaviors specific to each status source Sᵢ to be modeled.

When the status source under consideration is a network component for providing information about the presence of a terminal on a network, the obsolescence function is a stepwise constant function in the event of a presence status of the terminal on the network being subjected to a time out. Under such circumstances, the unit presence probability is constant until the time out has expired, and becomes zero after expiry thereof.

For a sensor that is situated in a public right of way, a function of the “decreasing exponential” type can be used for modeling the ephemeral nature of the presence of a user.

The person skilled in the art can also start from an approximate function and make use of a learning mechanism to end up with a function that is well adapted and possibly that incorporates several parameters relating to the user.

In particular, each obsolescence function Oᵢ can be selected depending on the kind of information provided by the corresponding status source Sᵢ and/or depending on the mode of operation of said status source.

By way of non-limiting example, the obsolescence function Oᵢ is of the following form:

Oᵢ(V)=pᵢ×V

where pᵢ designates the updated weight allocated to the variable V designating raw status information such as a unit presence probability V delivered by a status source Sᵢ. Oᵢ(V) then designates the unit presence probability V weighted by weight pᵢ.

By definition, the updated weight pᵢ is a weight that depends on the time and that is obtained by a time-varying weighting function written pᵢ(t), in which t is a variable specifying time. It should be observed that the updated weight pᵢ is normalized, i.e. that its value lies in the range [0,1]. Below, the updated weight pᵢ is expressed as a percentage (%) lying in the range 0 to 100%.

By way of non-limiting example, the time-varying weighting function pᵢ(t) may be selected from any one of the functions described below.

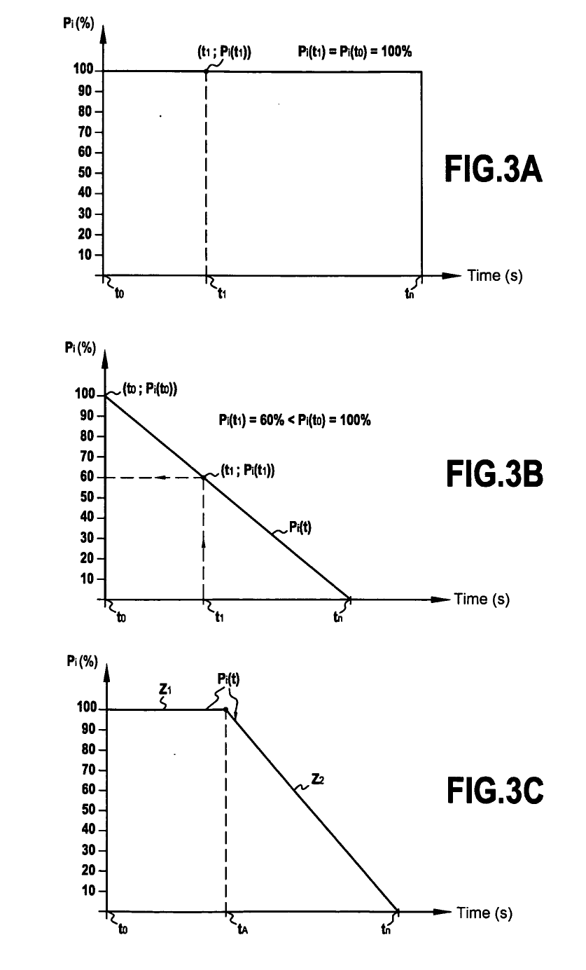

In a first example shown in FIG. 3A, the weighting function pᵢ(t) is a constant function of the type pᵢ(t)=a (where a is a real constant lying in the range 0 to 100%). This function, that is independent of time, makes it possible to escape from any obsolescence mechanism. By way of example, such a function can apply to status information provided by a network component serving to provide information about the presence of a terminal on a network. Under such circumstances, the information is network presence information. Such presence information remains valid over time between two consecutive updates performed by the network presence management component. For example, the information concerning the presence of a mobile terminal on a cellular network remains unchanged so long as the network presence management component does not detect a change in the connectivity status of the terminal on the network. Under such circumstances, the obsolescence mechanism does not apply, it being understood that this information concerns presence on the network and not presence of the user him or herself.

In a second example, shown in FIG. 3B, the weighting function pᵢ(t) is a function that decreases linearly as a function of time, i.e. a function of the type:

pᵢ(t)=b×t+c

where b is a negative real constant, and c designates a strictly positive real constant.

This type of function serves to damp down progressively the weight pi allocated to the variable V as a function of time t, the weighted information at each instant t being:

Oᵢ(Vᵢt)=(b×t+c)×V

This function applies to a status source from which the presence information provided at an initial instant looses its pertinence as from said initial instant and does so linearly as a function of age.

The slope of the line representative of pᵢ(t) may also be adjusted over time for a given status source, in order to model aging at a rate that is faster or slower over time (e.g. following an event triggered by the user). The slope of the line representative of pᵢ(t), as given by the constant b, can be adjusted as a function of the status source under consideration, assuming that the status information provided by certain status sources is likely to age more quickly than the information from other sources. Thus, where rapid aging applies, the absolute value of the constant b should be greater than when aging takes place more slowly.

In a third example shown in FIG. 3C, the weighting function pᵢ(t) is a function that is defined piecewise and comprising, for example, a level (constant zone: Z₁) followed by a decreasing piece (decreasing zone: Z₂) beginning at a predetermined time written t_{A}. This function serves to specify status information that ceases suddenly to be valid after a certain amount of time has elapsed (predetermined duration: t_{A}−t₀). The value of t_{A} may be adjusted so as to adapt advantageously to different status sources.

Such a function can be used with a source for which the minimum presence duration is known and/or predictable, e.g. a source enabling presence to be detected in an elevator, with the time spent in the elevator being considered as being some minimum constant time and with the user being constrained to remain inside the elevator for that time.

The kind of weighting function that can be selected, and consequently the kind of obsolescence function, is not limited to the above-described examples.

While remaining within the ambit of the present invention, the person skilled in the art can thus make use of any other function that makes it possible to model in realistic manner the aging (or obsolescent nature) of status information as provided by any given status source.

As shown in each of FIGS. 3A, 3B, and 3C, the updated weight pᵢ expressed as a percentage (%) is plotted up the ordinate axis as a function of time t expressed in seconds (s) and plotted along the abscissa axis.

In each of these examples, an initial time written t₀ designates the initial instant when the weight pᵢ is at a maximum (i.e. pᵢ(t₀)=100%), and a time written tₙ designates a final instant when the presence information provided by the source Sᵢ has lost all of its pertinence, and consequently has become obsolete (i.e. pᵢ(tₙ)=0%). Naturally, the value of the final instant tₙ is specific to each status source, it being understood that it depends on the obsolescence function selected for that source.

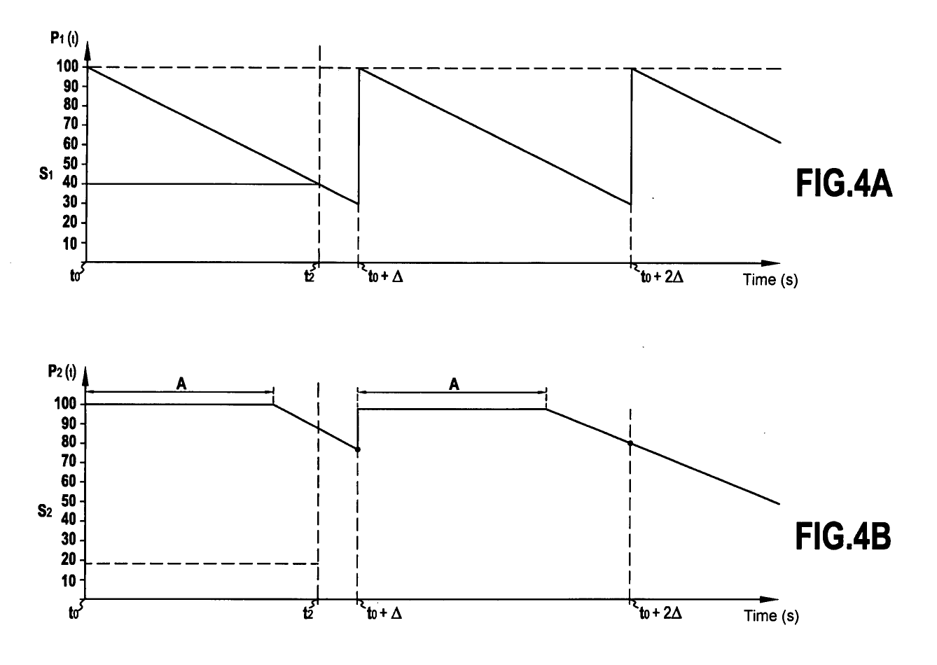

By way of example, FIG. 4 shows how the weight allocated to presence status information units from two different status sources written S₁ and S₂ varies as a function of time. This information is provided by the status sources at regular time intervals {t₀, t₀+Δ, t₀+2Δ, . . . , t₀+kΔ}, where Δ represents the time interval between two successive updating operations, and where k designates a natural integer.

More precisely, FIG. 4A shows the variation over time of the weight pᵢ relating to presence status information unit V₁ provided by a first status source S₁ associated with the terminal T, while FIG. 4B shows the variation over time of the weight p₂ relating to presence status information unit V₂ provided by a second status source S₂ associated with the same terminal T.

In this illustrative example, it is assumed that the information V₁ provided by the first source S₁ loses its pertinence linearly over time (in compliance with the function described with reference to FIG. 3B), whereas the information V₂ provided by the second source S₂ is weighted by a piecewise function (in compliance with the function described with reference to FIG. 3C).

At the initialization instant t₀, the first and second sources S₁ and S₂ provide information items V₁ and V₂. At this instant t₀, the pertinence of this information is total, given that it has just been transmitted by the respective status sources S₁ and S₂. Thus, the weights allocated to this information are at a maximum such that p₁(t₀)=p₂(t₀)=100%.

At a later instant t₂ (t₂>t₀), as shown in FIGS. 4A and 4B, the weight allocated to V₁ is 40% (p₁(t₂)=40%) while the weight allocated to V₂ is no more than 20% (p₂(t₂)=20%), whereas at the initial instant t₀, the pertinence of these two information units was at the maximum (p₁(t₀)=p₂(t₀)=100%), given that these two information units had just been updated by their respective status sources.

In accordance with the present invention, the weighting of the presence status information units takes account of the fact that the pertinence of this information varies over time.

Taking account of the aging of this information is particularly advantageous when the presence status of the user U needs to be determined with a high degree of reliability, e.g. at instant t₂, without necessarily needing to ask each status source to update its presence status information unit at said instant t₂.

In particular, this weighting makes it possible to improve the reliability of presence management systems that are not in a position to perform frequent updates from each status source.

By selecting an obsolescence function in an appropriate manner for each source, the aging of the information can be modeled to take account of the specific features of each source.

As shown in FIGS. 4A and 4B, by updating this information at the instant t₀+Δ, it is possible to reinitialize the weights to 100% (i.e. p₁(t₀+Δ)=p₂(t₀+Δ)=100%) after obtaining the presence information provided by the status sources. After this updating has been performed at instant t₀+Δ, each weight p₁, p₂ varies (decreases) over time over the interval [t₀, t₀+2Δ], in application of the previously defined respective weighting functions p₁(t) and p₂(t). This variation (decrease) takes place in the same manner as over the preceding time interval [t₀, t₀+Δ].

In this example, it is assumed, for any reason whatsoever, that during a second updating operation performed at instant t₀+2Δ, the second status source S₂ is not in a position to provide an update concerning its respective information V₂. Consequently, the weight V₂ is not reinitialized to a value 100%, but continues to lose value beyond t₀+2Δ following the linear decrease of the function p₂(t).

As shown in FIGS. 4A and 4B, the presence information units provided by the first and second status sources S₁, S₂ are weighted so that:

when new presence information units are provided during an updating operation, the weights that are allocated thereto are equal to 100%;

between two successive updating operations, the weights decrease in application of the predefined weighting function; and

if a new presence status information unit is not obtained during an updating operation, then the weight associated with the status information continues to decrease over time.

Consequently, the weighting serves to improve the pertinence of the information provided by modulating over time the weight that is allocated to said information in application of a predefined weighting function and as a function of updating operations. Weighting is advantageous specifically when at least one status source is not capable of updating its status information.

There follows a description of a particular embodiment of the present invention, in which the weighting method is implemented together with a method of aggregating data for the purpose of determining the presence status of a user.

In this example, the weighting method corrects the pertinence of the status information units that are used by the aggregator 100 to determine the probability of the user being present at each terminal. Thus, the weighting method makes it possible to improve the reliability of the presence status as determined by the aggregator 100.

In particular, the weighting makes it possible to improve the reliability with which the aggregated presence probability P is determined by the aggregator 100 during an aggregation step, by taking account of the aging of the status information units {Vᵢ} provided by the various status sources {Sᵢ}.

As shown in FIG. 2, the aggregator 100 of the invention comprises:

collector means 10 for collecting a plurality of unit presence probability values V₁, . . . , Vₙ provided respectively by the status sources S₁, . . . , Sₙ associated with the terminal T, this information being transmitted over the network 200 (not shown);

classifier means 20 for classifying the unit presence probability values V₁, . . . , Vₙ in increasing order, so as to form an ordered set E={V₁, . . . , Vₙ} of unit presence probability values, these values being for use in calculating the aggregated presence status probability P;

weighting means 35 for weighting the unit presence probability values as a function of a pertinence level calculated as a function of time in application of an above-described obsolescence function Oᵢ, so as to correct the weights pᵢ of the unit presence status probabilities over a determined time interval; and

calculator means 30 for calculating the aggregated presence status probability P from the unit presence probability values {V₁, . . . , Vₙ} classified in increasing order in the ordered set E.

In the invention shown in FIG. 2, the weighting means 35 are included/integrated in the calculator means 30.

The collector means 10, the classifier means 20, the calculator means 30, and the weighting means 35 of the aggregator 100 are constituted by software means implemented on a microprocessor associated with a random access memory (RAM) system and/or a ROM system.

The aggregator 100 used in the invention maintains a user presence status for each terminal, together with an aggregated presence probability. In order to maintain a presence status that is reliable over time, the collector means 10 of the aggregator 100 are adapted to interrogate a status source Sᵢ, where necessary, in order to refresh the presence status.

More specifically, the aggregator 100 has means for keeping up to date a presence table in which all of the terminals of each user are listed in association with presence information units. These updating means are constituted, for example, by software means implemented on a microprocessor associated with a RAM and/or ROM memory system.

For each terminal, the presence table stores an aggregated presence probability relating to the presence of the user at that terminal, together with a sub-table describing all of the status sources associated with the terminal. For each of the status sources, at least the following information is conserved in the sub-table:

the most recent unit presence status probability Vᵢ transmitted by each source Sᵢ; and

the date/time of the most recent transmission of each unit presence status probability Vᵢ. This date/time corresponds to the above-mentioned time stamp Zᵢ.

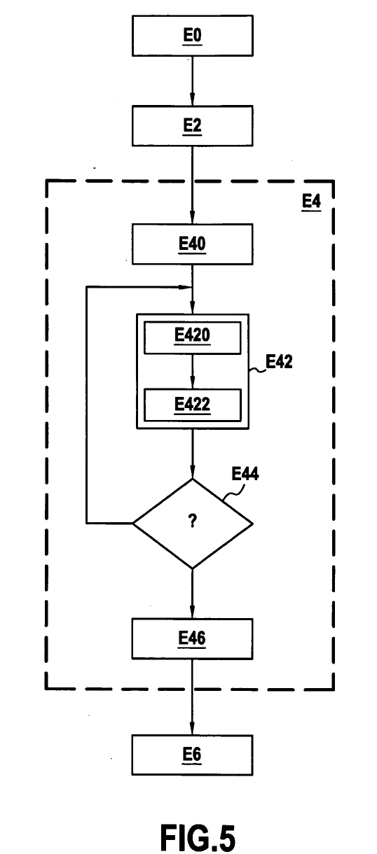

During an initial selection step E0 (FIG. 5), the aggregator 100 of the invention uses the collector means 10 to obtain unit presence status probability values Vᵢ as provided by each status source Sᵢ associated with the terminal T.

During a classification step E2, the classifier means 20 of the aggregator 100 of the invention classify the unit presence probability values V₁, . . . , Vₙ in increasing order so as to form an ordered set E={V₁, . . . , Vₙ} that is subsequently used for calculating the aggregated presence status probability P.

During a calculation step E4, the aggregated presence probability value P is calculated for each terminal T as a function of the unit presence probabilities Vᵢ provided by each status source Sᵢ. To do this, the calculator means 30 of the aggregator 100 co-operate with the weighting means 35 to calculate the aggregated presence status probability P=Mₙ by using the following recurrence formula:

Mᵢ=Mᵢ₋₁+Oᵢ(Vᵢ−Mᵢ₋₁) [Eq. 1]

with the initial condition M₀=0.5 and for all natural integers i such that 1≦i≦n, where:

n is a non-zero integer designating the last element of the set E, such that Vₙ=Max(E);

Vᵢ is a unit status presence probability provided by a status source designating the i^{th} value taken in said ordered set E of values sorted in increasing order; and

Oᵢ(V)=pᵢ(t)×V designate the obsolescence function associated with the source that provided the value V.

For each terminal T, the presence probability values aggregated by calculation using above formula (Eq. 1) serves to ensure that the result is normalized so that 0≦P≦1.

In this embodiment, it should be observed that the weighting and the calculation of the aggregated presence probability are intricate as shown by the following formula:

Mᵢ=Mᵢ₋₁+Oᵢ(Vᵢ−Mᵢ₋₁)

On each iteration, the quantity (Vᵢ−Mᵢ₋₁) is weighted in accordance with the invention. To do this, the weighting means 35 of the aggregator 100 allocates the weight pᵢ to this quantity (Vᵢ−Mᵢ₋₁) by applying the obsolescence function Oᵢ, such that:

Oᵢ(Vᵢ−Mᵢ₋₁)=pᵢ×(Vᵢ−Mᵢ₋₁)

During an initialization substep E40, the calculator means 30 perform initialization M₀=0.5, which corresponds to the initial condition for the above recurrence formula (Eq. 1).

During a calculation substep E42, the calculator means 30 apply the recurrence formula Eq. 1 so as to calculate:

M₁=M₀+O₁(V₁−M₀)

during a first iteration on the basis of the value M₀ initialized during the initialization substep E40 and of the unit presence probability value V₁ previously obtained during collection step E0.

For this purpose, the quantity (V₁−M₀) is weighted during a weighting step E420 in accordance with the invention. More precisely, the weighting means 35 of the aggregator 100 gives the weight pᵢ to said quantity (V₁−M₀) by applying the obsolescence function O₁ such that:

O₁(V₁−M₀)=p₁×(V₁−M₀)

during the weighting step E420. During a following calculation step E422, the calculator means 30 perform the following calculation:

M₁=M₀+O₁(V₁−M₀)

At the end of this calculation step, the value of M₁ as calculated in this way is stored, and the first iteration has terminated.

If there remain any elements to be processed in the ordered set E (test at E44 positive), then the calculator means 30 apply the above recurrence formula (Eq. 1) again.

Under such circumstances,

M₂=M₁+O₂(V₂−M₁)

is calculated during a second iteration starting with the value M₁ as calculated previously during the calculation substep E42 (first iteration), and from the unit presence probability value V₂ obtained during the collection step E0.

As described above, the weighting means 35 act during weighting step E420 to give a weight p₂ to the quantity (V₂−M₁) by applying the obsolescence function O₂ thereto, such that

O₂(V₂−M₁)=p₂×(V₂−M₁)

During the calculation step E422, the calculator means 30 add the value M₁ to the weighted information p₂×(V₂−M₁) so as to obtain the value M₂.

The calculation substep E42 and the test substep E44 are reiterated so long as there remain elements to be processed in the ordered set E, i.e. so long as the index i remains less than the number n.

When i=n, the calculator means 30 act together with the weighting means 35 to perform the following calculation:

Mₙ=Mₙ₋₁+Oₙ(Vₙ−Mₙ₋₁)

on the basis of the previously obtained values Vₙ and Mₙ₋₁ respectively calculated as described above. For this purpose, the weighting means 35 give the weight pₙ to the quantity (Vₙ−Mₙ₋₁) during the weighting step E420 so that the calculator means 30 add the value Mₙ₋₁ to this weighted quantity in order to obtain Mₙ.

Once all of the elements of the ordered set E have been processed by the calculator means 30 (when i>n), the aggregated presence probability P is obtained as being equal to Mₙ. During a final substep E46, the value Mₙ is stored (P=Mₙ).

During a sending step E6, the aggregator 100 sends in known manner the aggregated presence probability P as calculated in this way to the application server 1 via the network 200.

It should be observed that the calculation step E4 is carried out by the calculator means 30 and the weighting means 35 after the steps E0 and E2 of collecting and classifying unit probability values Vᵢ, and in response to any of the following events:

the collector means receiving a new presence information unit Vᵢ from a status source Sᵢ; and

the aggregator 100 receiving a request for which the aggregated presence probability P is considered as being not sufficiently precise or not sufficiently reliable, whereupon the calculation step E4 is executed after interrogating all or some of the status sources and obtaining updates from these sources during the collection step E0.

It should also be observed that the unit probability values are classified by increasing order during the classification step E2 prior to the calculation step E4, given that the calculation implementing the above formula Eq. 1 is an operation that is not commutative and that by convention it is desired to maximize presence probability.

Since the calculation operation is not commutative, classifying the unit presence probabilities guarantees results that are consistent and mutually comparable. In this example, classification in increasing order is used so as obtain presence probability values that are greater than would be obtained when classifying by decreasing order.

In accordance with an embodiment of the present invention, the steps of the method described above with reference to FIG. 5 are executed by instructions of a computer program. The program is recorded in a ROM 101 of the aggregator 100 which ROM constitutes a recording medium 101 for the computer program of the present invention.

In the implementation described above, the weighting step is performed in the aggregator 100 (by the weighting means 35) together with the step E4 of calculating the aggregated presence probability P, and more precisely during the calculation substep E42 preformed by the calculator means 30.

In another implementation, the weighting step is performed at each status source Sⱼᵢ at a terminal Tⱼ providing the source is capable itself of handling the obsolescence function Oⱼᵢ, and in particular of maintaining it.

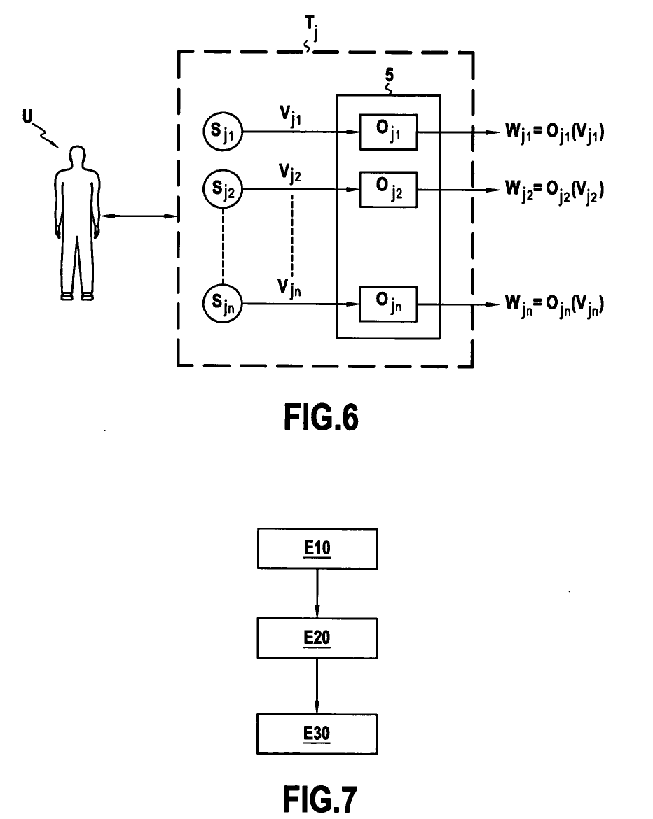

Alternatively, the weighting operation is performed by a weighting module 5 implemented in each terminal Tⱼ for the purpose of weighting the presence status information Vⱼᵢ provided as output from each associated status source Sⱼᵢ to said terminal Tⱼ as shown in FIG. 6.

By way of example, the weighting module 5 is constituted by software and/or hardware means implemented by a microprocessor associated with a RAM and/or ROM memory system of the terminal.

With reference to FIG. 7, during a weighting step E20, the weighting module 5 of the terminal Tⱼ corrects the values of the unit presence probability Vⱼᵢ obtained from each status source Sⱼᵢ during a collection step E10.

To do this, the weighting module 5 applies the obsolescence function Oⱼᵢ that is associated with the source Sⱼᵢ to the value Vⱼᵢ. At the end of the weighting step E20, the weighting module 5 outputs, for each status source Sⱼᵢ, a corrected unit presence probability Wⱼᵢ that is calculated in application of the following formula:

Wⱼᵢ=Oⱼᵢ(Vⱼᵢ)=pⱼᵢ×Vⱼᵢ [Eq. 2]

pⱼᵢ designating the updated weight allocated to the raw unit presence probability Vⱼᵢ by the status source Sⱼᵢ;

Sⱼᵢ designating the i^{th} source associated with the j^{th} terminal;

Vⱼᵢ designating the unit presence probability provided by the source Sⱼᵢ; and

j,i being non-zero integers respectively identifying a terminal and a status source associated with the terminal.

Thus, at the output from the weighting module 5, the weighted or corrected presence probabilities written Wⱼ₁, Wⱼ₂, . . . , Wⱼₙ are stored during a step E30 prior to being transmitted to an application making use thereof.

As described above, the updated weight pⱼᵢ is obtained by a weighting function pⱼᵢ(t) that is selected to match the status source Sⱼᵢ.

In order to optimize the execution time of the weighting step, and in the event that the number of sources Sⱼᵢ associated with the terminal Tⱼ is high, the weighting operation could be implemented in parallel. For this purpose, a plurality of weighting submodules 51, 52, . . . , 5n can be connected in parallel within the weighting module 5, as shown in FIG. 6.

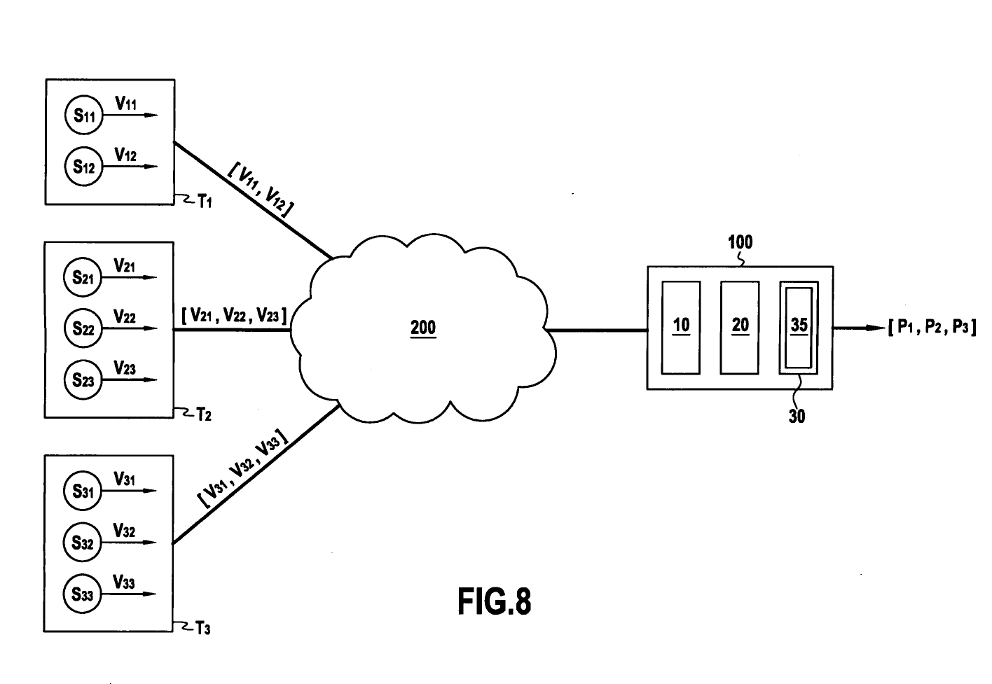

A detailed example of an application of the present invention is described below with reference to FIG. 8.

In this example, it is assumed that the user U has three terminals:

a fixed terminal T₁ located at home;

a dual-mode mobile terminal T₂ (Cellular/WiFi®) that can be kept on the user or put down near to the user; and

a fixed computer T₃ located at work.

Each of these terminals is associated with a plurality of status sources as described below.

The fixed terminal T₁ of the user U has the following two status sources:

a network presence supervisor S₁₂; and

an RFID scanner or detector S₁₁, the user wearing an RFID tag (e.g. in the form of a bracelet or a pendant).

The RFID detector S₁₁ is assumed to detect the presence of the RFID tag worn by the user U without making contact and within a radius of a few meters. The RFID detector S₁₁ generates periodic presence status information indicating whether the user U is or is not within its radio range.

The mobile terminal T₂ of the user U has the following three status sources:

a network presence supervisor S₂₃;

an inertial unit motion supervisor S₂₂; and

a network roaming supervisor S₂₁.

The network presence supervision is provided by the operator network. This generates a presence status indication whenever the mobile terminal T₂ registers with the network (together with the identity of the user), or on the contrary whenever the mobile terminal T₂ unregisters.

The inertial unit type supervisor S₂₂ incorporated in the mobile terminal T₂ generates an updating event on detecting a movement of the mobile terminal T₂. The inertial unit implements a hysteresis mechanism to limit the number of updates over time.

The network roaming supervisor S₂₁ generates an update event on detecting a change of status associated with the connectivity of the mobile terminal T₂. For example, a change of status is detected when the mobile terminal T₂ changes cell in the cellular network or when it comes within WiFi® range and connects to a WiFi® network.

The computer T₃ of the user U has the following three status sources:

an explicit declaration module S₃₃ for declaring the presence status of the user;

an activity supervisor S₃₂ for monitoring user activity by means of computer peripherals (keyboard, mouse); and

a supervisor S₃₁ associated with a webcam integrated in the computer screen, and capable of detecting a human form in front of the screen.

The module S₃₃ for explicitly declaring the presence of a user on the computer T₃ presents a graphical interface that enables the user U to specify his or her own presence status. This module also incorporates an asynchronous request function that periodically interrogates the user in order to ask the user to declare a current presence status. The graphical interface is designed ergonomically so as to enable presence status to be updated as simply and as quickly as possible while disturbing the user as little as possible.

Advantageously, the user is interrogated about the user's own presence status by the process implemented by the explicit declaration module, without it being necessary for the user to take care to keep his or her own presence status up to date over time.

The user activity supervisor S₃₂ periodically generates a presence status, whenever the computer T₃ detects user activity. As soon as the activity is interrupted, it updates the probability to zero and then stops sending update messages.

The supervisor S₃₁ associated with the webcam generates the same kind of periodic presence status so long as a human form is recognized as being in front of the screen of the computer T₃. In addition, it modulates the presence probability V₃₁ as a function of the result provided by the visual recognition process (confidence level in recognizing the human form or face).

It is assumed that the obsolescence functions associated with each of the above-described status sources (S₁₁, S₁₂, S₂₁, S₂₂, S₂₃, S₃₁, S₃₂, S₃₃), are constituted by respective linear functions.

Combined Implementation of Weighting with Aggregation

It is assumed that the current status of the table maintained by the aggregator 100 is as described in Table 1 below. The current value of the unit presence status probabilities Vⱼᵢ provided by the various status sources Sᵢ lie in the range 0 to 1, and the ages of these current values are expressed in seconds in the column headed “Age”.

TABLE 1

| | | | | Per source | |
|---|---|---|---|---|---|
| | | | | weighting | |
| | | | | (pⱼᵢ) | Normalized |
| | | Current raw | Age | (linear | aggregated |
| | | value | (Zⱼᵢ) | obsolescence | presence |
| Terminal/Status source | | (Vⱼᵢ) | (seconds) | function) | (Pⱼ) |
| Fixed terminal | Network presence | V₁₂ = 1 | 3600 | p₁₂ = 10% | P₁ = 0.325 |
| (T₁) | supervisor | | | | |
| | (S₁₂) | | | | |
| | RFID scanner | V₁₁ = 0 | 55 | p₁₁ = 50% | |
| | (S₁₁) | | | | |
| Mobile terminal | Network presence | V₂₃ = 1 | 600 | p₂₃ = 30% | |
| (T₂) | supervisor | | | | |
| | (S₂₃) | | | | |
| | Inertial unit | V₂₂ = 1 | 90 | p₂₂ = 75% | P₂ = 0.911625 |
| | (S₂₂) | | | | |
| | Network roaming | V₂₁ = 1 | 8200 | p₂₁ = 1% | |
| | (S₂₁) | | | | |
| Computer | Explicit declaration | V₃₃ = 1 | 3600 | p₃₃ = 10% | |
| (T₃) | module | | | | |
| | (S₃₃) | | | | |
| | Keyboard/mouse | V₃₂ = 1 | 210 | p₃₂ = 40% | P₃ = 0.811 |
| | activity (S₃₂) | | | | |
| | Webcam | V₃₁ = 0.75 | 35 | p₃₁ = 60% | |
| | (S₃₁) | | | | |

It should be observed that for each terminal T₁, T₂, T₃ in Table 1, the respective status sources S₁₁, S₁₂, S₂₁, S₂₂, S₂₃, S₃₁, S₃₂, S₃₃ are sorted by increasing presence values for each corresponding terminal T₁, T₂, T₃. The normalized aggregated presence probability values P₁, P₂, P₃ for each corresponding terminal T₁, T₂, T₃ are calculated by the above-described calculator means 30 and implementing the following recurrence formula:

Mⱼᵢ=Mⱼᵢ₋₁+pⱼᵢ×(Vⱼᵢ−Mⱼᵢ₋₁) [Eq. 2]

It should be observed that the formula referenced Eq. 2 above corresponds to the previously described recurrence formula Eq. 1 having an additional index j added thereto to specify the various terminals. In this example, j is a natural integer such as 1≦j≦3. The initial condition is Mⱼ₀=M₀=0.5.

As described above, on each iteration, the weighting means 35 of the aggregator 100 weight the quantity (Vⱼᵢ−Mⱼᵢ₋₁) by giving it the weight pⱼᵢ in application of the obsolescence function Oⱼᵢ so as to obtain:

Oⱼᵢ(Vⱼᵢ−Mⱼᵢ₋₁)=pⱼᵢ×(Vⱼᵢ−Mⱼᵢ₋₁)

which uses the calculator means 30 for calculating: during the calculation substep E42 described above with reference to FIG. 5.

For the computer T₃, the aggregated presence probability value is P₃=M₃₃ in which M₃₃ is obtained by recurrence during calculation step E4 as follows:

initialization substep E40: M₃₀=0.5 (initial condition);

calculation substep E42:

$$1 st interation \text{:} {M}_{31} = {M}_{30} + {0}_{3} ( {V}_{31} - {M}_{30} ) \\ = {M}_{30} + {p}_{31} \times ( {V}_{31} - {M}_{30} )$$

$${M}_{31} = 0.5 + 0.60 \times ( 0.75 - 0.5 ) = 0.65$$

$$2 nd interation \text{:} {M}_{32} = {M}_{31} + {p}_{32} \times ( {V}_{32} - {M}_{31} )$$

$${M}_{32} = 0.65 + 0.40 \times ( 1 - 0.65 ) = 0.79$$

$$3 rd interation \text{:} {M}_{33} = {M}_{32} + {p}_{33} \times ( {V}_{33} - {M}_{32} )$$

$${M}_{33} = 0.79 + 0.10 \times ( 1 - 0.79 ) = 0.811$$

### Independent Implementation of the Obsolescence Functions

In this configuration, the obsolescence functions are implemented independently in a device for processing presence status information relating to a presence status of a user. The processor device of the invention is constituted by a terminal of the user including above-described weighting means.

For example, such a processor device is constituted by a microprocessor associated with a ROM and/or RAM memory system and connected to the Internet by means of a network interface. The microprocessor runs a software application that serves to collect (collector means) the presence status information provided by the various status sources associated with the terminal. This software application includes software means (weighting means) for weighting the presence status information as a function of a pertinence level that is calculated as a function of time so as to correct the weighting of the presence status information over a determined time interval in accordance with the present invention.

Returning to the above-described scenario, in which the user U possesses three terminals T₁, T₂, T₃, Table 2 shows the result of the step of weighting raw unit presence probabilities Vⱼᵢ as obtained by the various status sources Sⱼᵢ of a given terminal Tⱼ.

The weighted presence probability

Wⱼᵢ=Oⱼᵢ(Vⱼᵢ)=pⱼᵢ×Vⱼᵢ

can be seen as being the probability that the user is indeed present from the point of view of the terminal and the status source Sⱼᵢ under consideration, given the amount of time that has elapsed since the most recent occasion on which presence information was generated and transmitted.

TABLE 2

| | | | | Per source | |
|---|---|---|---|---|---|
| | | | | weighting | |
| | | | | (pⱼᵢ) | Normalized |
| | | Current raw | Age | (linear | aggregated |
| | | value | (seconds) | obsolescence | presence |
| Terminal/Status source | | (Vⱼᵢ) | (Zⱼᵢ) | function) | (Wⱼᵢ = pⱼᵢ × Vⱼᵢ) |
| Fixed | Network presence | V₁₂ = 1 | 3600 | p₁₂ = 10% | W₁₂ = 0.10 |
| terminal | supervisor | | | | |
| (T₁) | (S₁₂) | | | | |
| | RFID scanner (S₁₁) | V₁₁ = 0 | 55 | p₁₁ = 50% | W₁₁ = 0.00 |
| Mobile | Network presence | V₂₃ = 1 | 600 | p₂₃ = 30% | W₂₃ = 0.30 |
| terminal | supervisor | | | | |
| (T₂) | (S₂₃) | | | | |
| | Inertial unit | V₂₂ = 1 | 90 | p₂₂ = 75% | W₂₂ = 0.75 |
| | (S₂₂) | | | | |
| | Network roaming | V₂₁ = 1 | 8200 | p₂₁ = 1% | W₂₁ = 0.01 |
| | (S₂₁) | | | | |
| Computer | Explicit declaration | V₃₃ = 1 | 3600 | p₃₃ = 10% | W₃₃ = 0.10 |
| (T₃) | module | | | | |
| | (S₃₃) | | | | |
| | Keyboard/mouse | V₃₂ = 1 | 210 | p₃₂ = 40% | W₃₂ = 0.40 |
| | activity | | | | |
| | (S₃₂) | | | | |
| | Webcam | V₃₁ = 0.75 | 35 | p₃₁ = 60% | W₃₁ = 0.45 |
| | (S₃₁) | | | | |

The updated weights pⱼᵢ are obtained from a linear function pⱼᵢ(t) that decreases over time, such that at a particular instant, the weights associated with the information units provided by the various sources are as specified in the “per source weighting (pⱼᵢ)” column of Table 1 above.

An external process enabling these various values would conclude that it is at the mobile terminal T₂ that the user U is most likely to be reachable. Nevertheless, the highest value remains well below the maximum 1, given that it is only 0.75.

The invention is described below in the context of an application to an emergency call service. Under such circumstances, it is assumed that a user application running on the application server 1 is an emergency call service application referred to as a “emergency call application” that needs to know the terminal or terminals at which a user can be reached, and with a high level of reliability in the event of an emergency.

To simplify, we return to the current status at instant t₁ of the presence table described above as Table 1. It is assumed here that the “emergency call application” operates from the application server 1 and sends a request to the aggregator 100, asking for the complete list of terminals where the probability of the user U being present is greater than 95%.

At instant t₁, the aggregated presence statuses for all three terminals T₁, T₂, T₃ are deemed to be insufficiently reliable because of their relatively great ages (8600 s, 3600 s) indicating that some of the status sources have not updated their presence status information recently.

Consequently, the aggregator 100 interrogates the sources that are suitable for being interrogated, i.e.:

the RFID scanner S₁₁ on the fixed terminal T₁;

the inertial unit supervisor S₂₂ of the mobile terminal T₂;

the network roaming observer S₂₁ of the mobile terminal T₂;

the explicit declaration module S₃₃ on the computer T₃;

the keyboard/mouse activity supervisor S₃₂ on the computer T₃; and

the supervisor associated with the webcam S₃₁ on the computer T₃.

During above-described collection step E0, the aggregator 100 obtains new unit presence probabilities from the collector means 10, and in response to the interrogations sent to the following status sources S₁₁, S₂₂, S₂₁, S₃₃, S₃₂, S₃₁, which new unit presence probabilities V₁₁, V₂₂, V₂₁, V₃₃, V₃₂, V₃₁ are provided by the various respective status sources.

At the end of the classification step E2 and of the calculation step E4 as described above, the aggregator 100 updates its presence table describing the current status at an instant t′₂>t′₁ and as described in Table 3 below.

When an aggregated presence probability calculation is not required by the “emergency call” application, only the weighted unit presence probabilities are calculated during the weighting step of the invention in accordance with the first implementation.

TABLE 3

| | | | | | Normalized |
|---|---|---|---|---|---|
| | | | Age | Per source | aggregated |
| | | Current value | (seconds) | weighting | presence |
| Terminal/Status source | | (Vⱼᵢ) | (Zⱼᵢ) | (pⱼᵢ) | (Wⱼᵢ = pⱼᵢ · Vⱼᵢ) |
| Fixed terminal | Network presence | V₁₂ = 1 | 3600 | p₁₂ = 10% | 0.10 |
| (T₁) | supervisor (S₁₂) | | | | |
| | RFID (S₁₁) scanner | V₁₁ = 0 | 0 | p₁₁ = 100% | 0 |
| | Network presence | V₂₃ = 1 | 600 | p₂₃ = 30% | 0.30 |
| | supervisor (S₂₃) | | | | |
| Mobile terminal | Inertial unit (S₂₂) | V₂₂ = 0 | 0 | p₂₂ = 100% | 0 |
| (T₂) | | | | | |
| | Network roaming | V₂₁ = 0 | 0 | p₂₁ = 100% | 0 |
| | (S₂₁) | | | | |
| | Explicit declaration | V₃₃ = 1 | 0 | p₃₃ = 100% | 1 |
| | module (S₁₃) | | | | |
| Computer | Keyboard/mouse | V₃₂ = 1 | 0 | p₃₂ = 100% | 1 |
| (T₃) | activity | | | | |
| | (S₁₂) | | | | |
| | Webcam (S₁₁) | V₃₁ = 0.75 | 0 | p₃₁ = 100% | 0.75 |

After the operation of updating the current values Vⱼᵢ, the age values associated with the unit presence probability values Vⱼᵢ are reset to zero (Zⱼᵢ=0), which has a considerable impact on the weighted presence status probabilities Wⱼᵢ.

With an “emergency call” application that requires an aggregated presence probability, the aggregator 100 acts in accordance with the invention to calculate the aggregated presence P₁, P₂, P₃ for each of the respective terminals T₁, T₂, T₃. Following this calculation step, the current status stored in the presence table of the aggregator 100 is as given in Table 4 below.

TABLE 4

| | | | | | Normalized |
|---|---|---|---|---|---|
| | | | Age | Per source | aggregated |
| | | Current value | (seconds) | weighting | presence |
| Terminal/Status source | | (Vⱼᵢ) | (Zⱼᵢ) | (pⱼᵢ) | (Pⱼ) |
| Fixed terminal | Network | V₁₂ = 1 | 3600 | p₁₂ = 10% | P₁ = 0.075 |
| (T₁) | presence | | | | |
| | supervisor (S₁₂) | | | | |
| | RFID scanner | V₁₁ = 0 | 0 | p₁₁ = 100% | |
| | (S₁₁) | | | | |
| Mobile terminal | Network | V₂₃ = 1 | 600 | p₂₃ = 30% | P₂ = 0.30 |
| (T₂) | presence | | | | |
| | supervisor (S₂₃) | | | | |
| | Inertial unit | V₂₂ = 0 | 0 | p₂₂ = 100% | |
| | (S₂₂) | | | | |
| | Network | V₂₁ = 0 | 0 | p₂₁ = 100% | |
| | roaming (S₂₁) | | | | |
| Computer | Explicit | V₃₃ = 1 | 0 | p₃₃ = 100% | P₃ = 1 |
| (T₃) | declaration | | | | |
| | module (S₁₃) | | | | |
| | Keyboard/ | V₃₂ = 1 | 0 | p₃₂ = 100% | |
| | mouse activity | | | | |
| | (S₁₂) | | | | |
| | Webcam (S₁₁) | V₃₁ = 0.75 | 0 | p₃₁ = 100% | |

From the results given in Table 4, only the computer T₃ satisfies the reliability criterion (aggregated presence probability P₃ greater than 95%). The aggregator 100 thus returns this information to the “emergency call” application, which can then continue processing in order to set up a call with the computer T₃ of the user U.

The user U is very likely in front of the computer T₃, but was previously busy with a task that did not give rise to activity on the peripherals (e.g. viewing a document). The explicit request module has had the effect of triggering the activity detector, which is beneficial to the desired result. The mobile terminal T₂ is probably within reach since it moved only a few tens of seconds ago. Nevertheless, during the interrogation, its inertial unit gave a negative response. As a result, the mobile terminal T₂ cannot be considered, in reliable manner, and in fact as being in the aggregated presence status, so it is set aside.

What is claimed is:

1. A method of processing presence status information relating to the presence status of a user at a terminal, said presence status information being provided by at least one status source associated with said terminal, said method comprising a weighting step during which said information is weighted as a function of a pertinence value that is calculated as a function of time.

2. A method according to claim 1, wherein each status source is associated with a pertinence level adapted to said source.

3. A method according to claim 1, wherein a presence information unit provided by a status source is constituted by a unit presence probability, said unit presence probability being corrected during the weighting step by applying an obsolescence function to said presence probability in such a manner as to obtain a corrected presence probability, said obsolescence function defining a pertinence level that is calculated as a function of time.

4. A method of updating the presence status of a user at at least one terminal connected to a telecommunications network, on the basis of presence status information provided by at least one status source of said terminal, wherein said presence status is determined during an aggregation step comprising:
collecting a plurality of unit presence probability values provided by a plurality of status sources associated with said terminal;
weighting said unit presence probability values in application of the processing method of claim 3; and
calculating an aggregated presence status probability resulting from a linear combination of said unit presence probability values.

5. A method according to claim 4, wherein during the aggregation step, the unit presence probability values are classified in increasing order so as to form an ordered set of values, prior to being used for calculating the aggregated presence status probability.

6. A method according to claim 5, wherein said aggregated presence probability P associated with said terminal is defined by P=Mₙ calculated by recurrence using the following formula:
Mᵢ=Mᵢ₋₁+Oᵢ(Vᵢ−Mᵢ₋₁)
with the following initial condition M₀=0.5; where i is a natural integer such that 1≦i≦n, with n designating the last element of said ordered set, and where Oᵢ designates the obsolescence function associated with the status source that provided the i^{th} unit presence probability value Vᵢ.

7. A device for processing presence status information relating to the presence status of a user at a terminal, said presence status information being provided by at least one presence source associated with said terminal, said device comprising means for weighting said presence status information as a function of a pertinence level calculated as a function of time.

8. A system for updating the presence status of a user at at least one terminal connected to a telecommunications network, each terminal being associated with at least one status source for providing presence status information about said user, said system comprising an data aggregator device comprising:
collector means for collecting a plurality of unit presence probability values provided by a plurality of status sources associated with said terminal;
weighting means for weighting said unit presence probability values as a function of a pertinence level calculated as a function of time; and
calculator means for calculating an aggregated presence status probability resulting from a linear combination of said unit presence probability values.

9. A system according to claim 8, including classifier means for classifying the unit presence probability values in increasing order so as to form an ordered set of values, prior to said values being used by said calculator means for calculating the aggregated presence status probability.

10. A system according to claim 9, wherein the calculator means are adapted to calculate the aggregated presence probability P defined by P=Mₙ, by recurrence using the following formula:
Mᵢ=Mᵢ₋₁+Oᵢ(Vᵢ−Mᵢ₋₁)
with the following initial condition M₀=0.5; where i is a natural integer such that 1≦i≦n, with n designating the last element of said ordered set, and where Oᵢ designates the obsolescence function associated with the status source that provided the i^{th} unit presence probability value Vᵢ.

11. A computer program including instructions for executing steps of the method according to claim 1 when said program is executed by a computer.

12. A recording medium readable by a computer having recorded thereon a computer program comprising instructions for executing the steps of the method according to claim 1.
